(19) United States
(12) Patent Application Publication
(10) Pub. No.: US 2026/0086857 A1
(43) Pub. Date: Mar. 26, 2026

(54) METHOD, APPARATUS, DEVICE, AND MEDIUM FOR MANAGING TOOL IN APPLICATION

(71) Applicant: Beijing Zitiao Network Technology Co., Ltd., Haidian District, Beijing (CN)

(72) Inventors: Qi Su, Beijing (CN); Qinghong Chen, Beijing (CN)

(21) Appl. No.: 19/103,977

(22) PCT Filed: Jun. 24, 2024
(86) PCT No.: PCT/CN2024/101059

§ 371 Date: Feb. 14, 2025

(51) Int. Cl. G06F 9/50

(52) U.S. Cl. CPC G06F 9/5027

(57) ABSTRACT

Provided are a method, apparatus, device and medium for managing a tool in an application. In one method, in response to a creation request for creating a tool in an application being received, a creation page is presented, the tool being used for performing a predetermined task, and the creation page including: a first area for specifying a description of the predetermined task represented in a natural language; and a second area for specifying a visual representation corresponding to the tool; in response to receiving an interaction request for the creation page, a tool is created based on the visual representation and the description of the predetermined task specified by the interaction request; and the visual representation corresponding to the tool is presented in the application.

### FIELD

Example implementations of the present disclosure relate generally to the field of computers, and in particular, to a method, an apparatus, a device, and a computer-readable storage medium for managing a tool in an application.

### BACKGROUND

With the development of computer technologies, a variety of applications for implementing different functions have been developed at present. The applications may provide different tools to perform various predetermined tasks. However, the tools are pre-set during application development, which cannot be modified by the user during use. At this point, it is desirable to manage tools in applications in a more flexible and efficient manner.

### SUMMARY

In a first aspect of the present disclosure, a method for managing a tool in an application is provided. In the method, in response to receiving a creation request for creating a tool in an application, a creation page is presented, the tool being used for performing a predetermined task, and the creation page including: a first area for specifying a description of the predetermined task represented in natural language; and a second area for specifying a visual representation corresponding to the tool; in response to receiving an interaction request for the creation page, the tool is created based on the visual representation and the description of the predetermined task specified by the interaction request; and the visual representation corresponding to the tool is presented in the application.

In a second aspect of the present disclosure, an apparatus for managing a tool in an application is provided. The apparatus includes a page presenting module, a creating module, and a tool presenting module. The page presenting module is configured to present a creation page, in response to receiving a creation request for creating a tool in the application, the tool being configured for performing a predetermined task, and the creation page including: a first area for specifying a description of the predetermined task represented in natural language; and a second area for specifying a visual representation corresponding to the tool. The creating module is configured to create, in response to receiving an interaction request for the creation page, the tool based on the visual representation and the description of the predetermined task specified by the interaction request. The tool presenting module is configured to present the visual representation corresponding to the tool in the application.

In a third aspect of the present disclosure, an electronic device is provided. The electronic device includes: at least one processing unit; and at least one memory coupled to the at least one processing unit and storing instructions for execution by the at least one processing unit that, when executed by the at least one processing unit, cause the electronic device to perform the method according to the first aspect of the present disclosure.

In a fourth aspect of the present disclosure, there is provided a computer readable storage medium having stored thereon a computer program which, when executed by a processor, causes the processor to implement the method according to the first aspect of the present disclosure.

In a fifth aspect of the present disclosure, there is provided a computer program product, including a computer program, where the computer program, when executed by a processor, implements the method according to the first aspect of the present disclosure.

It should be appreciated that what is described in this Summary is not intended to limit the key features or essential features of the implementations of the present disclosure, nor is it intended to limit the scope of the present disclosure. Other features of the present disclosure will become readily appreciated from the following description.

### BRIEF DESCRIPTION OF DRAWINGS

Hereinafter, the above and other features, advantages, and aspects of various implementations of the present disclosure will become more apparent with reference to the following detailed description taken in conjunction with the accompanying drawings. In the drawings, identical or similar reference signs denote identical or similar elements, where:

FIG. 1 illustrates a block diagram of an application environment according to an exemplary implementation of the present disclosure;

FIG. 2 illustrates a block diagram of managing a tool of an application according to some implementations of the present disclosure;

FIG. 3 illustrates a block diagram of creation page according to some implementations of the present disclosure;

FIG. 4 illustrates a block diagram of presenting a tool in an application according to some implementations of the present disclosure;

FIG. 5 illustrates a block diagram of presenting a tool in an application according to some implementations of the present disclosure;

FIG. 6 illustrates a block diagram of a setting page according to some implementations of the present disclosure;

FIG. 7 illustrates a flowchart of a method for managing a tool in an application according to some implementations of the present disclosure;

FIG. 8 illustrates a block diagram of an apparatus for managing a tool in an application according to some implementations of the present disclosure; and

FIG. 9 illustrates a block diagram of a device capable of implementing various implementations of the present disclosure.

### DETAILED DESCRIPTION

Embodiments of the present disclosure will be described in more detail below with reference to the accompanying drawings. Although certain implementations of the present disclosure are shown in the drawings, it should be understood that the present disclosure may be implemented in various forms and should not be construed as limited to the implementations set forth herein; rather, these implementations are provided for a thorough and complete understanding of the present disclosure. It should be understood that the drawings and implementations of the present disclosure are only for exemplary purposes and are not intended to limit the scope of protection of the present disclosure.

In the description of implementations of the present disclosure, the term “including” and its similar language should be understood as open-ended including, that is, “including but not limited to”. The term “based on” should be read as “based at least in part on”. The term “one implementation” or “the implementation” should be read as “at least one implementation”. The term “some implementations” should be understood as “at least some implementations”. Other explicit and implicit definitions may also be included below. As used herein, the term “model” may denote an association relationship between respective data. The association relationship may be obtained, for example, based on a variety of technical solutions that are currently known and/or will be developed in the future.

It is to be understood that the data involved in the technical solution (including but not limited to the data itself, the acquisition or use of the data) should comply with the requirements of the corresponding legal regulations and related provisions.

It should be understood that, before the technical solutions disclosed in the embodiments of the present disclosure are used, the user should be informed of the type of the personal information, the usage range, the usage scenario, and the like related to the present disclosure and the authorization of the user should be obtained in an appropriate manner according to relevant legal regulations.

For example, in response to receiving an active request from a user, prompt information is sent to the user to explicitly prompt the user that an operation requested by the user will require acquisition and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, a manner of sending prompt information to a user in response to receiving an active request from the user may be, for example, a manner of popping up a window, and the prompt information may be presented in a text manner in the pop-up window. In addition, the pop-up window may also carry a selection control for the user to select whether he/she “agrees” or “disagrees” to provide personal information to the electronic device.

It can be understood that, the above processes of notification and obtain of the user authorization are only illustrative, and do not limit the implementation of the present disclosure, and other methods meeting relevant legal regulations may also be applied to the implementation of the present disclosure.

As used herein, the term “in response to” refers to a state in which a corresponding event occurs or a condition is satisfied. It will be appreciated that the timing of the execution of a subsequent action that is performed in response to the event or condition, and the time at which the event occurs or condition is established, are not necessarily strongly correlated. For example, in some cases, subsequent actions may be performed immediately upon occurrence of an event or upon satisfaction of a condition; in other cases, subsequent actions may be performed only after a period of time has passed when an event occurs or a condition is established.

### Example Environment

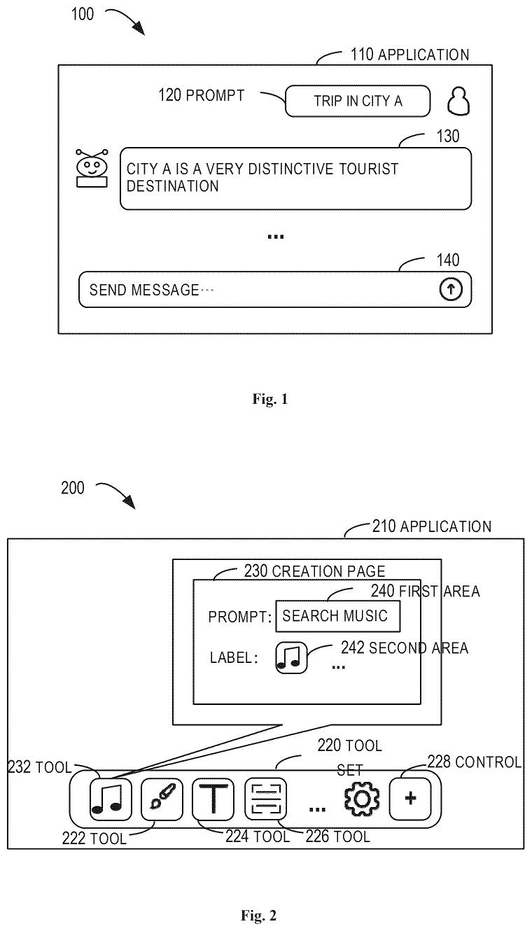

The application may provide different tools to perform various predetermined tasks. however, the tools are set during application development and cannot be modified by the user during use. With the development of machine learning model technology, a user may create and input a prompt to a machine learning model in order to execute a desired task. FIG. 1 illustrates a block diagram 100 of an application environment according to an exemplary implementation of the present disclosure. As shown in FIG. 1, in an application 110 implemented based on a machine learning model, a user may input a prompt in an input box 140, for example, the user may input “Trip in city A” and submit the prompt to the machine learning model. At this point, the machine learning model may generate a response based on the prompt 120.

However, a user needs to manually input a prompt to execute a desired task. In this case, it is expected that a tool may be created in an application to execute a specific task, so that the user directly calls the tool directly to execute the specific task in a subsequent process of using the application.

### Summary of Tool Management

In order to at least partially address the deficiencies in the prior art, according to one exemplary implementation of the present disclosure, a method for managing a tool in an application is proposed. To summarize, a tool can be created within an application, and a user can specify a task that the tool can execute and a visual representation of the tool (e.g., a control, etc.). An overview of one exemplary implementation according to the present disclosure is described with reference to FIG. 2, which illustrates a block diagram 200 of managing a tool in an application according to some implementations of the present disclosure. As illustrated in FIG. 2, in response to receiving a creation request for creating a tool in an application 210 (e.g., a click operation for a control 228, etc.), a creation page 230 can be presented in the application 210 to create a tool for executing a predetermined task. In this way, users may be enabled to create personalized tools in the application 210 on their own demand.

As shown in FIG. 2, the creation page 230 may include: a first area 240 for specifying a description of a predetermined task represented in natural language; and a second area 242 for specifying a visual representation corresponding to the tool. In particular, the description can be a prompt for calling a processing system to execute a predetermined task, where the processing system can include a first subsystem that is implemented based on a search engine, and/or a second subsystem that is implemented based on a machine learning model. One or more subsystems may be called based on specific content of the prompt, so as to execute a corresponding task. Herein, a visual representation of the tool (e.g., a label or icon) can be specified in the second area 242, e.g., text can be entered in the second area 242, or an image can be selected, so as to specify the visual representation.

Further, in response to receiving an interaction request for a creation page, a tool (e.g., tool 232) may be created based on visual representation and a description of a predetermined task specified by the interaction request, and a visual representation corresponding to the tool may be presented in the application. In other words, the visual representation of the created tool will be displayed in the application for use by the user. As shown in FIG. 2, a user may click on a control 228 to create one or more tools. A created tool can be added to a tool set 220, e.g., a tool 222 can be used to process images, a tool 224 can be used to translate text, and a tool 226 can be used to generate a summary, etc. In this way, a custom tool can be added to the application, thereby supporting a user calling the tool to perform desired tasks in a simpler and efficient manner.

### Detailed Process of Tool Management

Having described an overview of some implementations according to the present disclosure, in the following, more details of some implementations according to the present disclosure will be described. According to some implementations of the present disclosure, in response to receiving a call request for a visual representation, a description can be sent to a processing system to perform a predetermined task, and a processing result for the call request can be provided based on a response to the description from the processing system. With continued reference to FIG. 2, in response to receiving a call request (e.g., a click operation) for a tool 232, result of a search for music may be presented in application 210, e.g., links for accessing one or more music pieces, and/or the searched music may be played by application 210, etc. It should be understood that the various tools in the tool set 220 are merely illustrative and that, alternatively and/or additionally, the tool set 220 can include more, fewer, or different tools.

It should be appreciated that the predetermined tasks may involve a variety of situations. For example, for tasks such as searching for music, querying the weather of city A, etc., such tasks do not involve data objects to be processed. For another example, for a translation task, an image processing task, and the like, a data object to be processed needs to be specified, and in this case, the creation page can further include more set regions. According to some implementations of the present disclosure, the creation page may further include a third area for specifying a data source of the at least one data object to be processed by the predetermined task.

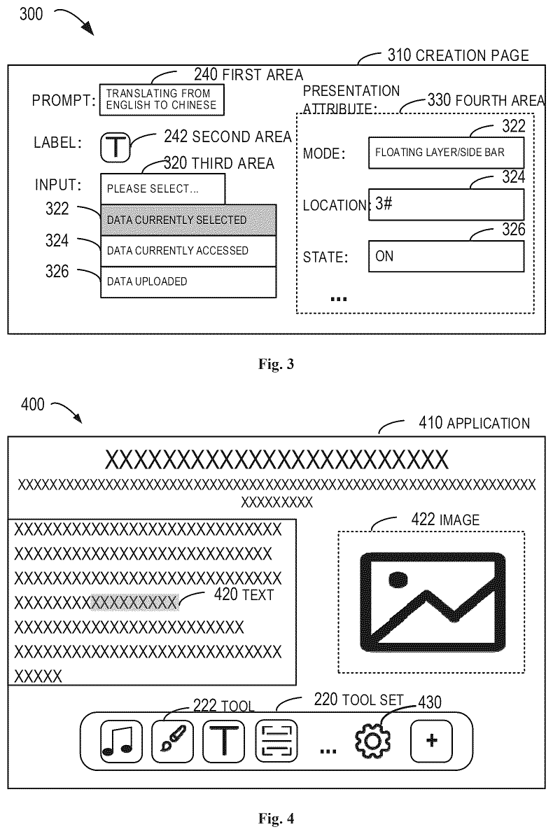

Further details are described with reference to FIG. 3, which illustrates a block diagram 300 of a creation page, in accordance with some implementations of the present disclosure. As illustrated in FIG. 3, the creation page 310 may include a third area 320 for specifying a data source of at least one data object to be processed by a predetermined task. Assuming that the prompt specify a translation task of “Translate from English to Chinese”, a drop-down list may be provided in the third area 320 to specify the data source of the text to be translated. The data source may include at least any one of data accessed in the application, data selected in the application, and data submitted to the application. For example, an option 322 may specify translation of “Data currently selected”, an option 324 may specify a translation of “Data currently accessed” and an option 326 may specify a translation of “Data uploaded”, etc.

Specifically, data accessed in an application may be used as a default to-be-processed data object, for example, a user is browsing a web page, and clicks a “translation” tool 222, and in this case, the web page may be translated into a specified language. Assuming that the user selects some portion of the web page, the portion may be translated to a specified language. For another example, after clicking the “translation” tool 222, a predetermined page can be presented, and the user can upload the to-be-processed data object, e.g., a file to be translated, to a specified location of the predetermined page.

If the user selects the option 322 in the creation page 310, the data source to be processed at this point is the “Data currently selected”, details thereof will be described with respect to FIG. 4. FIG. 4 illustrates a block diagram 400 of presenting a tool in an application, in accordance with some implementations of the present disclosure. As shown in FIG. 4, a tool set 220 can be presented in an application 410 in a floating manner. Herein, a user can drag the tool set 220 and present it in a desired location. Alternatively, and/or additionally, the tool set may not be presented during an initial stage, and in response to determining that the user selected a particular data object, one or more tools for processing the particular data object may be presented.

According to some implementations of the present disclosure, types of data objects accessed in an application may be obtained; and in response to determining that the type of a data object matches the predetermined task, the visual representation is presented in the application. In particular, assuming that the user accesses a certain web page in application 410 and selects text 420, a tool set may be presented at a location near the selected text. Herein, the tool set may include only one or more tools capable of processing data of text type, e.g., a translation tool, and a tool that generate abstract, etc. As another example, assuming that the user selected an image 422, a tool set may be presented near the selected image. Herein, the tool set may include only one or more tools capable of processing data of image type, e.g., an image processing tool, etc. With example implementations of the present disclosure, a user may be provided with tools that may need to be called, thereby simplifying user operations.

According to some implementations of the present disclosure, in response to receiving a call request for the visual representation, a description may be sent to a processing system. In particular, at least one data object can be obtained based on a data source, and a description and corresponding to-be-processed data may be sent to a processing system. For example, the selected text 420 and the prompt “Translating from English to Chinese” may be sent to the processing system to call the processing system to return the Chinese translation of the text 420. In this way, the powerful processing power of the remote processing system can be called to perform the desired task without modifying the codes of the application.

According to some implementations of the present disclosure, whether the obtained type of the data object matches a predetermined task may be pre-compared, that is, whether the data object can be used as input data of the predetermined task. In response to determining that the type of the at least one data object matches the predetermined task, the description can be sent to the processing system. In the above example, since the task of “Translating from English to Chinese” can process the selected text 420, the type of the data object at this point matches the predetermined task, and the prompt “Translating from English to Chinese” and the selected text 420 can be sent to the processing system. As another example, assuming that the image 422 is currently selected and text is included in the image, the prompt “Translating from English to Chinese” and the selected image 422 may still be sent to the processing system. At this point, the processing system return the Chinese translation of the text in the image 422.

Alternatively and/or additionally, in accordance with some implementations of the present disclosure, in response to determining that the type of the at least one data object does not match the predetermined task, a notification is provided in the application to indicate to the user to re-designate the at least one data object. With continued reference to FIG. 4, assuming that Chinese text 420 is currently selected and the user clicks on the tool 222 to perform the image processing task. At this point, since the image processing task cannot process the text, a notification may be provided in the application 410 to inform the user to re-select an image to be processed. In this manner, it can be ensured that the processing system can perform specified tasks, thereby avoiding large amounts of non-executable tasks from being sent to the processing system, thereby avoid increasing the workload of the processing system.

Although the foregoing illustrates a case in which the predetermined task involves one data object, alternatively and/or additionally, the predetermined task may involve a plurality of data objects. For example, the prompt may include: “Merging two documents”, then at this point the user may upload two documents to be merged into the designated area, and the processing system will return the merged document.

According to some implementations of the present disclosure, the creation page further includes: a fourth area for specifying a presentation attribute of the visual representation, the presentation attribute including at least any one of a mode, a location, and a state of the visual representation; and presenting the visual representation in the application includes presenting the visual representation in accordance with the presentation attributes. Returning to FIG. 3 to describe more detail, the creation page 310 may further include a fourth area 330, and the fourth area 330 may include input regions 322, 324, and 326.

In particular, the input area 322 may be used to specify a mode of the visual representation, where the mode may include, for example, a “floating layer” mode and a “side bar” mode. The “floating layer” mode may display the tool in the floating layer in a manner shown in FIG. 4. The “side bar” mode may specify that the tool is presented in a side fixed area in the application. Input area 324 may specify a location of the visual representation, e.g., a location number, or coordinates, etc. of the visual representation in the tool set. The input area 324 may specify a state of the visual representation, e.g., whether the visual representation is displayed in the tool set (“ON”may indicate display, and “OFF”may indicate not display).

According to some implementations of the present disclosure, the application may include a web application, and the method described above may be implemented with a plug-in of a browser for accessing the web application. Specifically, a web application may be accessed in a browser application (i.e., an address of the web application is accessed), and then a creation page for creating a tool is presented in the web application. The above-mentioned functions can be realized in a plug-in of a browser. In this way, when a browser is used to access different web applications, the functions defined in the browser plug-in can be called to customize a tool in the different web applications. According to some implementations of the present disclosure, an activation state of a browser plug-in may be set. For example, the technical solution of the present disclosure may be executed only when the browser plug-in is activated. In the event that the browser plug-in is not activated, the browser may be operated in a conventional manner.

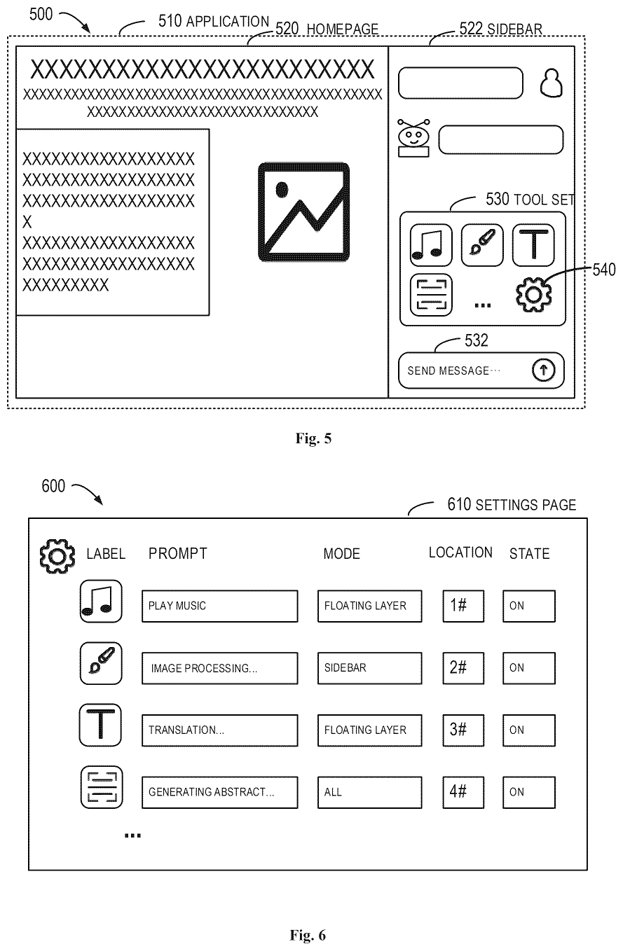

FIG. 5 illustrates a block diagram 500 of presenting a tool in an application in accordance with some implementations of the present disclosure. As shown in FIG. 5, an interaction page for calling a processing system may be integrated in the browser plug-in. In this case, the display area of the application 510 may be divided into two parts: a main page 520 and a sidebar 522. The main page 520 is used to display an interaction page of the application 510, and the sidebar 522 is used to display an interaction page between the user and the processing system.

At this time, a tool set 530 and an input area 532 may be presented in the side bar 522. The user may click on each tool in the tool set 530 to perform a desired task. Alternatively, and/or additionally, the user may enter a prompt in the input area 532 to call the capabilities of the processing system to perform a corresponding task. In this manner, the tool set can be presented at a fixed location, thereby facilitating user to access.

According to some implementations of the present disclosure, a user can a add tool to a tool set based on the manner described above. In the plug-in of the browser, a storage area for storing a user-defined tool may be set. At this time, the tool may be added to the plug-in in response to receiving an adding request. In this way, it may be convenient for the user to continuously add a plug-in for specifying a certain function during use.

According to some implementations of the present disclosure, a settings page can be provided for managing tools in a tool set, e.g., in response to detecting an interaction request for a settings control (e.g., control 430 in FIG. 4, and control 540 in FIG. 5), the settings page can be presented. More details are described with reference to FIG. 6. FIG. 6 illustrates a block diagram 600 of a settings page in accordance with some implementations of the present disclosure. As shown in FIG. 6, the settings page 610 may provide relevant parameters of each tool that the user has added, and the user may add a new tool, delete an existing tool, or modify a label, a prompt, a mode, a location, a state, and the like of an existing tool in the settings page. With example implementations of the present disclosure, it may be convenient for a user to fully understand various tools supported by the plug-in of the current browser.

According to some implementations of the present disclosure, for another web application accessed using a browser, a tool set that matches a type of the another web application is determined from a plurality of tools; and a tool set is presented in another web application. Assuming that a user is accessing a web application for text editing, a text processing tool set can be presented, and the tool set may include one or more tools for processing text, e.g., a translation tool, a summary-generation tool, etc. For another example, assuming that the user is accessing a web application for image editing, an image processing tool set may be presented, and the tool set may include one or more tools for processing text, such as an image style conversion tool, an image color conversion tool, etc. In this manner, sharing user-defined tools between different types of web applications may be facilitated.

With example implementations of the present disclosure, customized tools may be added to applications to support users calling the tools to perform desired tasks in a simpler and efficient manner.

### Example Process

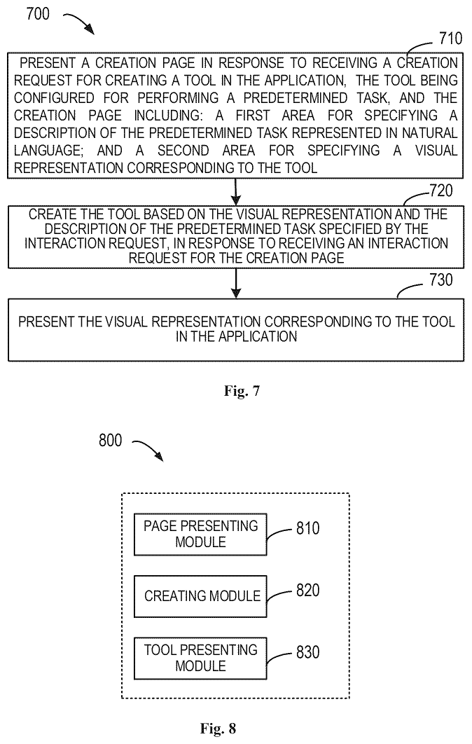

FIG. 7 illustrates a flowchart of a method 700 for managing a tool in an application, according to some implementations of the present disclosure. At block 710, in response to receiving a creation request for creating a tool in an application, a creation page is presented, the tool is configured for performing a predetermined task, and the creation page including: a first area for specifying a description of the predetermined task in natural language; and a second area for specifying a visual representation corresponding to the tool. At block 720, in response to receiving an interaction request for the creation page, the tool is created based on the visual representation and the description of the predetermined task specified by the interaction request. At block 730, the visual representation corresponding to the tool is presented in the application.

According to some implementations of the present disclosure, the method further includes: in response to receiving a call request for the visual representation, sending the description to a processing system to perform the predetermined task; and providing a processing result for the call request based on a response to the description from the processing system.

According to some implementations of the present disclosure, the creation page further includes: a third area for specifying a data source of at least one data object to be processed by the predetermined task, the data source including at least any of data accessed in the application, data selected in the application, and data submitted to the application.

According to some implementations of the present disclosure, sending the description to the processing system includes: obtaining the at least one data object based on the data source; and in response to determining that a type of the at least one data object matches the predetermined task, sending the description to the processing system.

According to some implementations of the present disclosure, the method further includes: in response to determining that the type of the at least one data object does not match the predetermined task, providing a notification in the application to instruct the user to re-specify the at least one data object.

According to some implementations of the present disclosure, presenting the visual representation in the application includes: obtaining a type of a data object accessed in the application; and in response to determining that the type of the data object matches the predetermined task, presenting the visual representation in the application.

According to some implementations of the present disclosure, the creation page further includes: a fourth area for specifying a presentation attribute of the visual representation, the presentation attribute including at least one of: a mode, a location, and a state of the visual representation; and presenting the visual representation in the application includes presenting the visual representation according to the presentation attribute.

According to some implementations of the present disclosure, the application is a web application, and the method is implemented with a plug-in of a browser for accessing the web application.

According to some implementations of the present disclosure, the method 700 further includes, in response to receiving the add request, adding a tool to the plug-in.

According to some implementations of the present disclosure, a plug-in includes a plurality of tools, and the method 700 further includes: for another web application accessed using the browser, determining, from the plurality of tools, a tool set matching a type of the another web application; and presenting the tool set in the other web application.

### Example Apparatus and Device

FIG. 8 illustrates a block diagram of an apparatus 800 for managing a tool in an application according to some implementations of the disclosure. The apparatus includes: a page presenting module configured to present a creation page, in response to receiving a creation request for creating a tool in the application, the tool being configured for performing a predetermined task, and the creation page including: a first area for specifying a description of the predetermined task represented in natural language; and a second area for specifying a visual representation corresponding to the tool; a creating module 820 configured to create, in response to receiving an interaction request for the creation page, the tool based on the visual representation and the description of the predetermined task specified by the interaction request; and a tool presenting module 830 configured to present the visual representation corresponding to the tool in the application.

According to some implementations of the present disclosure, the apparatus 800 further includes: a sending module configured to send, in response to receiving a call request for the visual representation, the description to a processing system to perform the predetermined task; and a providing module configured to provide a processing result for the call request based on a response to the description from the processing system.

According to some implementations of the present disclosure, the creation page further incudes: a third area for specifying a data source for the at least one data object to be processed by the predetermined task, the data source including at least any of data accessed in the application, data selected in the application, and data submitted to the application.

According to some implementations of the present disclosure, the sending module is further configured to: obtain the at least one data object based on the data source; and in response to determining that a type of the at least one data object matches the predetermined task, send the description to the processing system.

According to some implementations of the present disclosure, the sending module is further configured to, in response to determining that the type of the at least one data object does not match the predetermined task, provide a notification in the application instructing the user to re-specify the at least one data object.

According to some implementations of the present disclosure, the tool presenting module 830 is further configured to: obtain a type of data object accessed in the application; and in response to determining that the type of the data object matches the predetermined task, presenting the visual representation in the application.

According to some implementations of the present disclosure, the creation page further includes: a fourth area for specifying a presentation attribute of the visual representation, the presentation attribute including at least one of: a mode, a location, and a state of the visual representation; and the tool presentation module is further configured to: present the visual representation according to the presentation attribute.

According to some implementations of the present disclosure, the application is a web application, and the method is implemented with a plug-in of a browser for accessing the web application.

According to some implementations of the present disclosure, the apparatus 800 further includes: in response to receiving the add request, adding the tool to the plug-in.

According to some implementations of the present disclosure, the plug-in includes a plurality of tools, and the tool presenting module is further configured to: for another web application accessed using the browser, determine, from the plurality of tools, a tool set matching a type of the another web application; and present the tool set in the another web application.

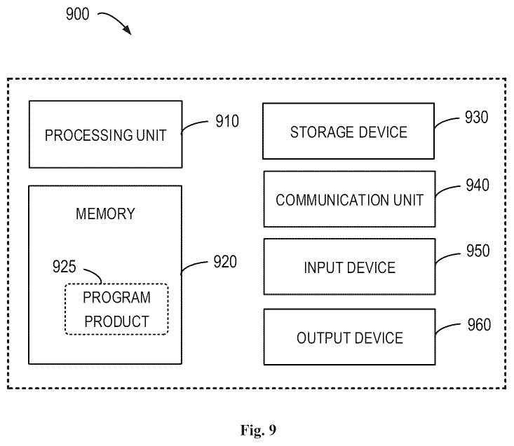

FIG. 9 illustrates a block diagram of a device 900 in which one or more implementations of the present disclosure may be implemented. It should be understood that the computing device 900 shown in FIG. 9 is merely exemplary and should not constitute any limitation on the functionality and scope of the implementations described herein. The computing device 900 shown in FIG. 9 may be used to implement the above-described method.

As shown in FIG. 9, the computing device 900 is in the form of a general-purpose computing device. Components of the computing device 900 may include, but are not limited to, one or more processors or processing units 910, a memory 920, a storage device 930, one or more communications units 940, one or more input devices 950, and one or more output devices 960. The processing unit 910 may be an actual or virtual processor and can perform various processes according to programs stored in the memory 920. In a multiprocessor system, a plurality of processing units execute computer executable instructions in parallel, so as to improve the parallel processing capability of the computing device 900.

The computing device 900 typically includes a number of computer storage media. Such media may be any available media that are accessible by the computing device 900, including, but not limited to, volatile and non-volatile media, removable and non-removable media. The memory 920 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 930 may be a removable or non-removable medium and may include a machine-readable medium such as a flash drive, a magnetic disk, or any other medium that can be used to store information and/or data (e.g., training data for training) and that can be accessed within the computing device 900.

The computing device 900 may further include additional removable/non-removable, volatile/nonvolatile storage media. Although not shown in FIG. 9, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 920 may include a computer program product 925 having one or more program modules configured to perform various methods or actions of various implementations of the present disclosure.

The communication unit 940 implements communication with other computing devices through a communication medium. In addition, functions of components of the computing device 900 may be implemented by a single computing cluster or a plurality of computing machines, and these computing machines can communicate through a communication connection. Thus, the computing device 900 may operate in a networked environment using logical connections to one or more other servers, network personal computers (PCs), or another network node.

The input device 950 may be one or more input devices such as a mouse, keyboard, trackball, etc. The output device 960 may be one or more output devices such as a display, speaker, printer, etc. The computing device 900 may also communicate with one or more external devices (not shown) such as a storage device, a display device, or the like through the communication unit 940 as required, and communicate with one or more devices that enable a user to interact with the computing device 900, or communicate with any device (e.g., a network card, a modem, or the like) that enables the computing device 900 to communicate with one or more other computing devices. Such communication may be performed via an input/output (I/O) interface (not shown).

According to an exemplary implementation of the present disclosure, a computer readable storage medium is provided, on which a computer-executable instruction is stored, where the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above. According to an exemplary implementation of the present disclosure, there is provided a computer program product, having a computer program stored thereon, the program, when being executed by a processor, implements the above-described method.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

1. A method for managing a tool in an application, comprising:
presenting a creation page in response to receiving a creation request for creating a tool in the application, the tool being configured for performing a predetermined task, and the creation page comprising:
a first area for specifying a description of the predetermined task represented in natural language; and
a second area for specifying a visual representation corresponding to the tool;
creating the tool based on the visual representation and the description of the predetermined task specified by the interaction request, in response to receiving an interaction request for the creation page; and
presenting the visual representation corresponding to the tool in the application.

2. The method of claim 1, further comprising:
sending the description to a processing system to perform the predetermined task, in response to receiving a call request for the visual representation; and
providing a processing result for the call request based on a response to the description from the processing system.

3. The method of claim 2, wherein the creation page further comprises: a third area for specifying a data source of at least one data object to be processed by the predetermined task, the data source comprising at least any of data accessed in the application, data selected in the application, and data submitted to the application.

4. The method of claim 3, wherein sending the description to the processing system comprises:
obtaining the at least one data object based on the data source; and
sending the description to the processing system, in response to determining that a type of the at least one data object matches the predetermined task.

5. The method of claim 4, further comprising: providing, in response to determining that the type of the at least one data object does not match the predetermined task, a notification in the application to indicate the user to re-specify the at least one data object.

6. The method of claim 1, wherein presenting the visual representation in the application comprises:
obtaining a type of a data object accessed in the application; and
presenting the visual representation in the application, in response to determining that the type of the data object matches the predetermined task.

7. The method of claim 1, wherein the creation page further comprises: a fourth area for specifying a presentation attribute of the visual representation, the presentation attribute comprising at least any of: a mode, a location, [[and]]or a state of the visual representation; and
wherein presenting the visual representation in the application comprises presenting the visual representation according to the presentation attribute.

8. The method of claim 1, wherein the application is a web application, and the method is implemented with a plug-in of a browser for accessing the web application.

9. The method of claim 8, further comprising adding the tool to the plug-in in response to receiving an add request.

10. The method of claim 9, wherein the plug-in comprises a plurality of tools, and the method further comprises:
for another web application accessed using the browser, determining, from the plurality of tools, a set of tools matching a type of the another web application; and
presenting the set of tools in the another web application.

11. (canceled)

12. An electronic device, comprising:
at least one processor; at least one memory coupled to the at least one processor and storing instructions for execution by the at least one processor that, when executed by the at least one processor cause the electronic device to perform acts comprising:
presenting a creation page in response to receiving a creation request for creating a tool in the application, the tool being configured for performing a predetermined task, and the creation page comprising:
a first area for specifying a description of the predetermined task represented in natural language, and
a second area for specifying a visual representation corresponding to the tool;
creating the tool based on the visual representation and the description of the predetermined task specified by the interaction request, in response to receiving an interaction request for the creation page; and
presenting the visual representation corresponding to the tool in the application.

13-14. (canceled)

15. The device of claim 12, further comprising:
sending the description to a processing system to perform the predetermined task, in response to receiving a call request for the visual representation; and
providing a processing result for the call request based on a response to the description from the processing system.

16. The device of claim 15, wherein the creation page further comprises: a third area for specifying a data source of at least one data object to be processed by the predetermined task, the data source comprising at least any of data accessed in the application, data selected in the application, or data submitted to the application.

17. The device of claim 16, wherein sending the description to the processing system comprises:
obtaining the at least one data object based on the data source; and
sending the description to the processing system, in response to determining that a type of the at least one data object matches the predetermined task.

18. The device of claim 17, further comprising: providing, in response to determining that the type of the at least one data object does not match the predetermined task, a notification in the application to indicate the user to re-specify the at least one data object.

19. The device of claim 12, wherein presenting the visual representation in the application comprises:
obtaining a type of a data object accessed in the application; and
presenting the visual representation in the application, in response to determining that the type of the data object matches the predetermined task.

20. The device of claim 12, wherein the creation page further comprises: a fourth area for specifying a presentation attribute of the visual representation, the presentation attribute comprising at least any of: a mode, a location, or a state of the visual representation; and
wherein presenting the visual representation in the application comprises presenting the visual representation according to the presentation attribute.

21. The device of claim 12, wherein the application is a web application, and the method is implemented with a plug-in of a browser for accessing the web application.

22. The device of claim 21, further comprising adding the tool to the plug-in in response to receiving an add request.

23. A non-transitory computer readable storage medium having a computer program stored thereon, the computer program, when executed by a processor, causes the processor to implement a method comprising:
presenting a creation page in response to receiving a creation request for creating a tool in the application, the tool being configured for performing a predetermined task, and the creation page comprising:
a first area for specifying a description of the predetermined task represented in natural language, and
a second area for specifying a visual representation corresponding to the tool;
creating the tool based on the visual representation and the description of the predetermined task specified by the interaction request, in response to receiving an interaction request for the creation page; and
presenting the visual representation corresponding to the tool in the application.
